(19) United States
(12) Patent Application Publication
(10) Pub. No.: US 2026/0161532 A1
(43) Pub. Date: Jun. 11, 2026

(54) SYSTEM AND METHOD FOR OPTIMIZING APPLICATION TESTING

(71) Applicant: The Toronto-Dominion Bank, Toronto (CA)

(72) Inventors: Sudheer BATTULA, Ajax (CA); Rajeev SUNDARRAJAN, Oshawa (CA); Senthil Priya SUBRAMANIAM, Ajax (CA)

(21) Appl. No.: 18/971,808

(22) Filed: Dec. 6, 2024

(51) Int. Cl. G06F 11/3668; G06F 40/58

(52) U.S. Cl. CPC G06F 11/3688; G06F 40/58

(57) ABSTRACT

Computing platforms, methods, and storage media for executing a test execution command in relation to an application element of an application are disclosed. Exemplary implementations may: receive a test execution command for a first end user of an application, the test execution command including a variable associated with the application element of an application; obtain a first language preference of the first end user of the application; translate the variable to a first language-specific value for the application element based on the first language preference of the first end user; and execute the test execution command in relation to the application element based on the first language-specific value.

### FIELD

The present disclosure relates to optimizing application testing, including but not limited to computing platforms, methods, and storage media for executing a test execution command in relation to an application element of an application.

### BACKGROUND

A software application may be used by different end users, and there is often a need to provide the application in different languages to the different end users. The different languages may be required by local laws and/or may be based on linguistic preferences as indicated by the different end users. When executed in the different languages, the software application will have different implementations of application elements. For example, a user interface button in the software application may indicate “Sign In” in an English version, and may indicate “Se connecter” in a French version.

When the software application is to be provided in different languages, developing and testing the software application in the various language versions can be burdensome. In some instances, there is the additional work involved for coding the application itself to provide the different language versions of the software application and related user interface. There is also the additional work in testing the application, for example, to test user behavior in relation to different language versions of the application software. Conventionally, a separate test may be executed in order to test the software application for each language version of the software application. Improvements in approaches to optimize application testing are desirable.

### BRIEF DESCRIPTION OF THE DRAWINGS

Embodiments of the present disclosure will now be described, by way of example only, with reference to the attached Figures.

FIG. 1 is a schematic diagram illustrating an operating environment in accordance with one or more embodiments of the present disclosure.

FIG. 2 is a block diagram of an example computing platform which may be used to implement examples of the present disclosure.

FIG. 3 illustrates a method for executing a test execution command in relation to an application element of an application, in accordance with one or more embodiments.

FIG. 4 is a block and flow diagram illustrating the present system and method according to an embodiment of the present disclosure.

FIG. 5 is a block and flow diagram illustrating how language preferences of the end users may be obtained according to an embodiment of the present disclosure.

FIG. 6 is a block and flow diagram illustrated how translations may be obtained based on language preferences according to an embodiment of the present disclosure.

FIG. 7 illustrates steps and example software code for test execution in relation to an application under test according to a known approach.

FIG. 8 illustrates steps and example software code for test execution in relation to an application under test according to an embodiment of the present disclosure.

### DETAILED DESCRIPTION

Computing platforms, methods, and storage media for executing a test execution command in relation to an application element of an application are disclosed. Exemplary implementations may: receive a test execution command including a variable associated with an application element of an application; obtain a first language preference of a first end user of the application; translate the variable to a first language-specific value for the application element based on a master translation database and the first language preference of the first end user; and execute the test execution command in relation to the application element based on the first language-specific value.

The present disclosure provides a platform to develop and run a single test to automatically test multiple language versions of the same software process, in some applications, with a single line of code.

One aspect of the present disclosure relates to a computing platform configured for executing a test execution command in relation to an application element of an application. The computing platform may include a non-transient computer-readable storage medium having executable instructions embodied thereon. The computing platform may include one or more hardware processors configured to execute the instructions. The processor(s) may execute the instructions to receive a test execution command including a variable associated with an application element of an application. The processor(s) may execute the instructions to obtain a first language preference of a first end user of the application. The processor(s) may execute the instructions to translate the variable to a first language-specific value for the application element based on a master translation database and the first language preference of the first end user. The processor(s) may execute the instructions to execute the test execution command in relation to the application element based on the first language-specific value.

Another aspect of the present disclosure relates to a method for executing a test execution command in relation to an application element of an application. The method may include receiving a test execution command including a variable associated with an application element of an application. The method may include obtaining a first language preference of a first end user of the application. The method may include translating the variable to a first language-specific value for the application element based on a master translation database and the first language preference of the first end user. The method may include executing the test execution command in relation to the application element based on the first language-specific value.

Yet another aspect of the present disclosure relates to a non-transient computer-readable storage medium having instructions embodied thereon, the instructions being executable by one or more processors to perform a method of executing a test execution command in relation to an application element of an application. The method may include receiving a test execution command including a variable associated with an application element of an application. The method may include obtaining a first language preference of a first end user of the application. The method may include translating the variable to a first language-specific value for the application element based on a master translation database and the first language preference of the first end user. The method may include executing the test execution command in relation to the application element based on the first language-specific value.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

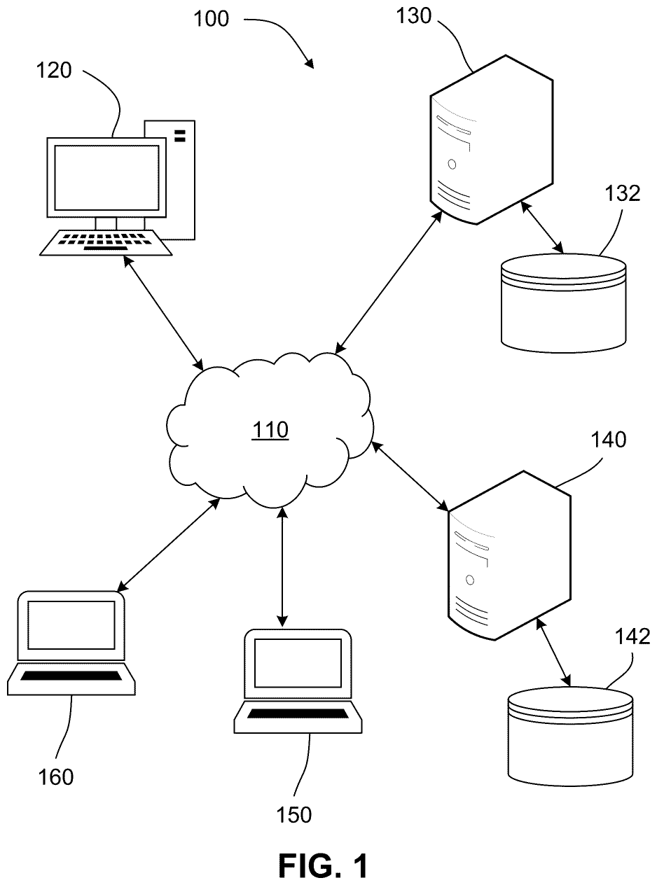

FIG. 1 is a schematic diagram illustrating an operating environment 100 configured to optimize application testing, including but not limited to executing a test execution command in relation to an application element of an application. The operating environment 100 in this example includes a tester device 120, a first computing system (such as a testing computing system 130), and a second computing system (such as a testee computing system 140). In some implementations, the tester device 120 may be associated with an application tester or quality engineer (QE), who is testing an application hosted on the testee computing system 140 via the testing computing system 130. FIG. 1 illustrates the testing computing system 130 and the testee computing system 140 as separate and distinct computing devices or apparatuses. However, these systems may not be separate physical systems. For example, the testing computing system 130 and the testee computing system 140 may be implemented in software associated with a common processor.

The testing computing system 130 may include a testing data store 132 and the testee computing system 140 may include a testee data store 142. While the testing and testee data stores 132 and 142 are illustrated to be external to their respective systems, in other implementation, the data stores 132 and 142 may be included in the testing computing system 130 and the testee computing system 140, respectively.

In some embodiments, the operating environment 100 may include one or more client devices, such as first and second client devices 150, 160. The first and second client devices 150, 160 may be respectively associated with first and second end users of the application, and the first and second end users may have user accounts with the testee computing system 140 and/or the testing computing system 130. Account information of the first and second end users may be stored in the testee data stores 142 and/or the testing data store 132.

The operating environment 100 may further comprise a network 110. The network 110 may be an internetwork such as may be formed of one or more interconnected computer networks. For example, such a network may be or may include an Ethernet network, an asynchronous transfer mode (ATM) network, a wireless network, or the like. In some implementations, the network 110 may be the Internet. The network 110 allows the tester device 120, the first computing system 130, the second computing system 140, and the first and second client devices 150, 160 to communicate with one another.

As noted above, software applications may be used by a number of different end users. In the illustrated embodiment, the software application may be provided to the end users by the second computing system or the testee computing system 140. In an alternative implementation, the software application may be provided to the end user through the second computing system in combination with the first computing system, such as the testee computing system 140 in combination with the testing computing system 130. The software application may be accessed by the different end users via the first and second client devices 150, 160. There is often a need to provide the software application in different languages to the end users, such as based on linguistic preferences set by the end users. The linguistic preferences for each of the end users may be stored in the testee data store 142, the testing data store 132, or both.

With numerous end users using the software application in multiple different languages, development of the software application can become burdensome. In addition to the coding of the application itself (to provide the different language versions of the software application and related user interface), testing of the software application to characterize user behavior in relation to different language versions can become burdensome. There is a technical problem associated with known approaches in that multiple lines of code are often used for testing multiple language versions of the same application. Such repetitive coding and execution of same often results in use of excessive memory and processing resources to accomplish an otherwise relatively simple task. The present operating environment 100 provides a technical solution by eliminating the need to write separate lines of code for each language version of the software application. Rather, a variable is included in the code, and is replaced at runtime with a language-specific value based on an end user's language preference.

In that regard, the tester device 120 may be configured to generate and send a test execution command for one or more end users for one or more language versions of the application, rather than a separate test execution command for each language version of the software application. In the depicted embodiment of FIG. 1, the test execution command from the tester device 120 may be first sent to the testing computing system 130.

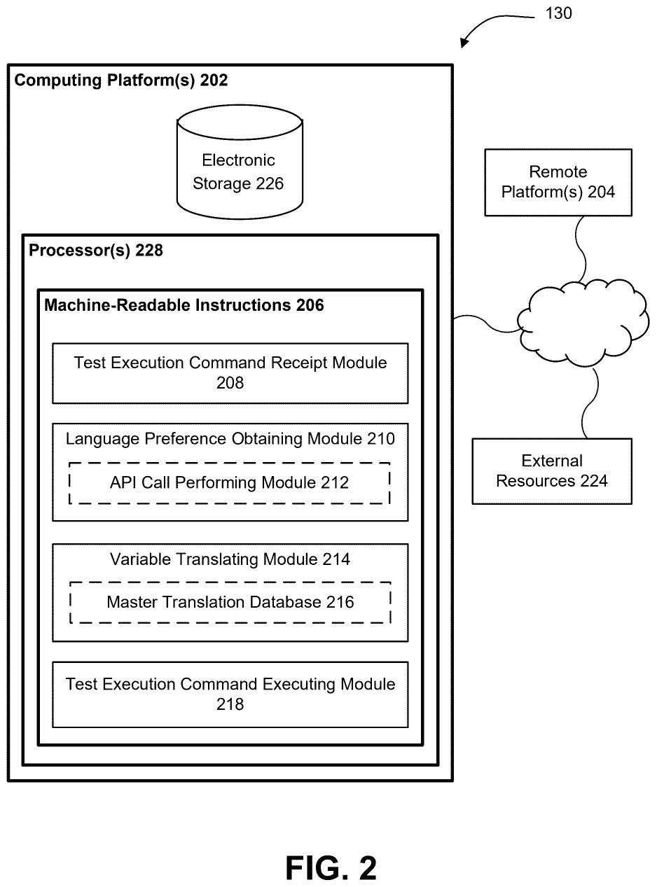

FIG. 2 illustrates in further details of the testing computing system 130 configured for executing a test execution command in relation to an application element of an application, in accordance with one or more embodiments. In some embodiments, the testing computing system 130 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access the testing computing system 130 via remote platform(s) 204 such as using the first and second client devices 150, 160.

Computing platform(s) 202 may be configured by machine-readable instructions 206. Machine-readable instructions 206 may include one or more instruction modules. The instruction modules may include computer program modules. The instruction modules may include one or more of a test execution command receipt module 208, a language preference obtaining module 210, a variable translating module 214, a test execution command executing module 218, and/or other instruction modules.

The test execution command receipt module 208 may be configured to receive a test execution command for one or more end users of a software application, such as a first end user and a second end user. The test execution command may be received from the tester device 120. The test execution command includes a variable associated with an application element of the software application. For example, the application element may be a user interface button in the software application. In use, the user interface button may indicate “Sign In” in an English version, and may indicate “Se Connecter” in a French version. Thus, the variable associated with the application element may be a language variable. As the test execution command may be for one or more end users of the software application, the test execution command may further include an identifier for each of the one or more end users, such as the first and second end users. It will be understood that the test execution command may further include identifiers for end users in addition to the first and second end users.

The language preference obtaining module 210 may be configured to obtain one or more language preferences of the one or more end users of the application. The one or more language preferences of the one or more end users may be specified by the end users and may be specific to the software application. For example, the language preference obtaining module 210 may be configured to obtain a first language preference of the first end user of the application, where the language preference of the first end user may be previously specified by the first end user and saved in or otherwise associated with the first end user's account. The language preference of the first end user may have been selected specifically for the application. In another implementation, the language preference obtaining module 210 may be configured to obtain the first language preference and another language preference of the first end user of the application, such as a primary language preference and a secondary language preference of the same end user. The primary and secondary language preferences of the first end user may also have been previously specified by the first end user and saved in or otherwise associated with the first end user's account. The language preferences of the first end user may also have been selected specifically for the application. The first end user's specified language preference(s) for the application may be different from the first end user's default system language preference, such as the default system language preference for the first client device 150.

In another implementation, when the test execution command may be for the first and second end users of the software application, the language preference obtaining module 210 may be configured to obtain the first language preference of the first end user and a second language preference of the second end user. The first and second language preferences of the first and second end users may also have been selected specifically for the software application. It will be understood that the language preference obtaining module 210 may be configured to obtain additional language preference for additional end users via the same test execution command.

To obtain the one or more language preferences of the one or more end users, the one or more language preferences of the one or more end users may simply be retrieved from memory, such as from the testing data store 132. For example, the primary and secondary language preferences of one end user, or the first and second language preferences for the first and second end users. may be retrieved from the testing data store 132 using the identifiers of the first and second end users. The one or more language preferences of the one or more end users may be each of the user's default language for the application or they may be previously selected by each of the end users and stored in the testing data store 132.

In an alternative implementation, the one or more language preferences of the one or more end users may be obtained using an application programming interface (API) call. In that regard, the language preference obtaining module 210 may further comprise an API call performing module 212 that may be configured to perform an API call based on the identifier(s) of the one or more end users using the one or more communications modules. The API call may be performed with the software application, which may be hosted by the testee computing system 140. The API call may alternatively be placed with another third-party database or computing system.

In relation to the depicted embodiment of FIG. 1, the API call performing module 212 may place the API call to the testee computing system 140 to obtain the first language preference of the first end user. In other implementations, the API call performing module 212 may place the API call to the testee computing system 140 to obtain the primary (and secondary) language preference(s) of one end user, and/or to obtain the first and second language preferences for the first and second end users. In that regard, the one or more language preferences of the one or more end users may be stored in the testee data store 142. The one or more language preferences of the one or more end users may be each of the user's default application language preferences or they may have been previously selected by each of the end users for the application and stored in the testee data store 142, such as in a feature file. The one or more language preferences of the one or more end users may be different from a default language of the software application or different from the end user's system language preference.

In a further implementation, the language preference obtaining module 210 may be configured to obtain the language preferences of one of the end users by retrieving them from memory, while obtaining the language preferences of another one of the end users using an API call. Other variations are possible.

After obtaining the one or more language preferences of the one or more end users, the variable translating module 214 may be configured to translate the language variable in the test execution command to a first language-specific value for the application element based the first (or primary) language preference of the first end user. The variable translating module 214 may further be configured to translate the language variable in the test execution command to the first language-specific value based on a master translation database 216. The master translation database 216 may comprise reference translations of the application elements of the software application in the multiple languages the software application is available and/or used in. The master translation database 216 may be a standard translation database or may be previously generated or customized for the purposes of the application.

The master translation database 216 may be stored in and accessed from a variety of locations, including the testee data store 142, the testing data store 132, or electronic storage 226 (as described further below). The variable translating module 214 may, thus, be configured to translate the language variable in the test execution command to the first language-specific value for the application element based the master translation database and the first (or primary) language preference of the first end user.

In implementations where the language preference obtaining module 210 obtained the primary and secondary language preferences of the same first end user, the variable translating module 214 may be configured to further translate the variable to another language-specific value for the application element based on the master translation database and the secondary language preference of the first end user. In implementations where the language preference obtaining module 210 obtained the first and second language preferences of the first and second end users, the variable translating module 214 may be configured to correspondingly further translate the variable to a second language-specific value for the application element based on the master translation database and the second language preference of the second end user.

After the one or more language-specific values for the application element are obtained, the test execution command executing module 218 may be configured to execute the test execution command in relation to the application element based on the one or more language-specific values. To that end, the test execution command executing module 218 may send the test execution command with the one or more language-specific values for the application element to the testee computing system 140 to continue execution. During execution, the variable is replaced at runtime with the applicable language-specific value for the application element. If multiple language-specific values are sent with the test execution command, the test execution command may be run multiple times, with the variable being replaced each runtime with one of the multiple language-specific values.

For example, if the variable translating module 214 generated the language-specific value and the other language-specific value for the application element based on the primary and secondary language preference of the same first end user, the test execution command executing module 218 may be configured to execute the test execution command twice in relation to the application element, based on each of the two language-specific values. If the variable translating module 214 generated the first language-specific value and the second language-specific value for the application element based on the first and second language preferences of the first and second end users, the test execution command executing module 218 may be configured to execute the test execution command twice in relation to the application element, initially based on the first language-specific value and then based on the second language-specific value.

After the test execution command has been executed/run with each of the language-specific values, the testing computing system 130 may be configured to receive the output(s) from the testee computing system 140, and send the output(s) from the executed test execution command to the tester device 120 for comparison with expected outputs.

Notably, the system as presently described allows for the use of one test execution command, in the form of one line of code, to be sent from the tester device 120 for the testing computing system 130 to perform the above-described processes. In return, the tester device may receive one or more testing outputs. In this manner, use of the presently disclosed system and method may help to reduce repetitive coding by the tester or QE, and may help to reduce the amount of memory and processing resources needed to accomplish an otherwise repetitive task. As well, the system as presently described may further help to reduce the use of processing resources by allowing for the language preference(s) of the end user(s) to be dynamically obtained without the tester or QE having to spend the time and processing resources to do so beforehand. The test execution command sent from the tester device 120 may specify the identity of the first (and optionally other additional) end users, but does not have to specify the end user(s) language preference(s) to proceed. Moreover, should the language preference(s) of the end user(s) change and the preferences are updated (for example, in the testing data store 132 and/or the testee data store 142), the present system is configured to work with the most up-to-date information without requiring the tester or QE to know or spend time and processing resources to find out that the language preference(s) have changed.

In some embodiments, computing platform(s) 202, remote platform(s) 204, and/or external resources 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 224 may be operatively linked via some other communication media.

A given remote platform 204 may include one or more processors configured to execute computer program modules. The computer program modules may be configured to enable an expert or user (such as an application tester) associated with the given remote platform 204 (such as the tester device 120) to interface with the testing computing system 130 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 224 may include sources of information outside of the testing computing system 130, external entities participating with the testing computing system 130, and/or other resources. In some embodiments, some or all of the functionality attributed herein to external resources 224 may be provided by resources included in the testing computing system 130. In the depicted embodiment, external resources 224 may include the testee computing system 140.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

The electronic storage 226, and the testing data store 132 may comprise non-transitory storage media that electronically stores information. The electronic storage media may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). The electronic storage 226 and the testing data store 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 226 and the testing data store 132 may include one or more virtual storage resources (e.g., cloud storage, a virtual private network, and/or other virtual storage resources). The electronic storage 226 and the testing data store 132 may store software algorithms, information determined by processor(s) 228, information received from computing platform(s) 202, information received from remote platform(s) 204, and/or other information that enables computing platform(s) 202 to function as described herein.

The processor(s) 228 may be configured to provide information processing capabilities in the computing platform(s) 202. As such, the processor(s) 228 may include one or more of a digital processor, an analog processor, a digital circuit designed to process information, an analog circuit designed to process information, a state machine, and/or other mechanisms for electronically processing information. Although the processor(s) 228 is shown in FIG. 2 as a single entity, this is for illustrative purposes only. In some embodiments, the processor(s) 228 may include a plurality of processing units. These processing units may be physically located within the same device, or the processor(s) 228 may represent processing functionality of a plurality of devices operating in coordination. The processor(s) 228 may be configured to execute the modules 208, 210, 212, 214, 216, 218, and/or other modules. Processor(s) 228 may be configured to execute modules 208, 210, 212, 214, 216, 218, and/or other modules by software; hardware; firmware; some combination of software, hardware, and/or firmware; and/or other mechanisms for configuring processing capabilities on processor(s) 228. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, and/or 218 are illustrated in FIG. 2 as being implemented within a single processing unit, in embodiments in which processor(s) 228 includes multiple processing units, one or more of modules 208, 210, 212, 214, 216, and/or 218 may be implemented remotely from the other modules. The description of the functionality provided by the different modules 208, 210, 212, 214, 216, and/or 218 described below is for illustrative purposes, and is not intended to be limiting, as any of modules 208, 210, 212, 214, 216, and/or 218 may provide more or less functionality than is described. For example, one or more of modules 208, 210, 212, 214, 216, and/or 218 may be eliminated, and some or all of its functionality may be provided by other ones of modules 208, 210, 212, 214, 216, and/or 218. As another example, processor(s) 228 may be configured to execute one or more additional modules that may perform some or all of the functionality attributed below to one of modules 208, 210, 212, 214, 216, and/or 218.

The operating environment 100 and the testing computing system 130 may thus be configured to handle testing of an application element in multiple languages with a single line of code. The present disclosure helps to reduce human dependency, thereby reducing human error, and helps to reduce the inefficient use of computing resources and memory (i.e. the need to repeatedly execute similar test commands in order to test the same application element in different language versions).

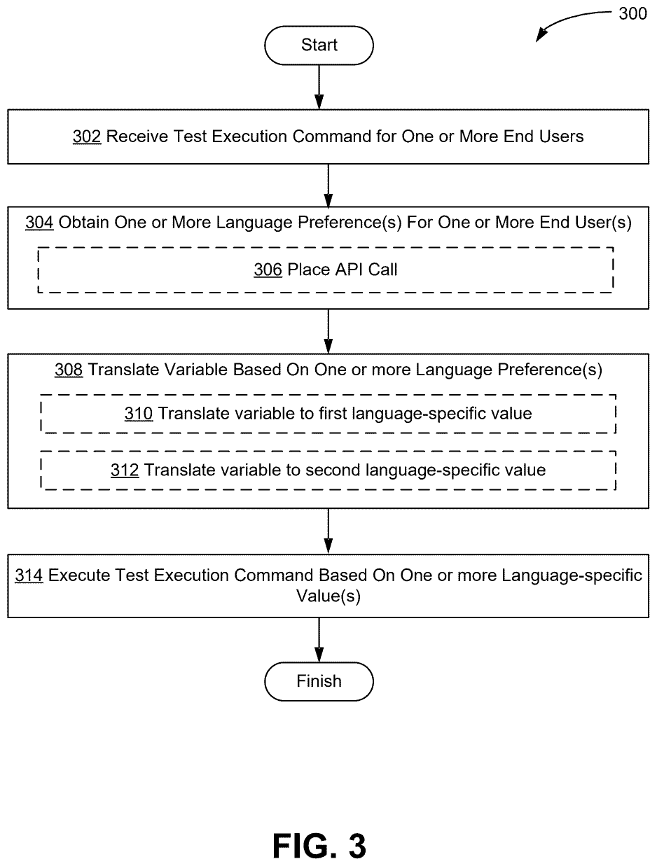

FIG. 3 illustrates a method 300 for executing a test execution command in relation to an application element of an application, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300. In some embodiments, the method 300 may be implemented in the operating environment 100 with the testing computing system 130 described above.

An operation 302 may include receiving a test execution command. The test execution command may be for one or more end users of the application, whereby the test execution command may include a variable associated with an application element of the application, such as a language variable. The test execution command may further include an identifier for each of the one or more end users, such as first and second end users. Operation 302 may be performed by one or more hardware processors configured by machine-readable instructions including a module that is the same as or similar to test execution command receipt module 208, in accordance with one or more embodiments.

An operation 304 may include obtaining one or more language preferences of the one or more end users of the application. The operation 304 may be performed by one or more hardware processors configured by machine-readable instructions including a module that is the same as or similar to the language preference obtaining module 210, in accordance with one or more embodiments. The operation 304 may further comprise an operation 306, whereby an API call may be placed to a third-party or external computing system to obtain the one or more language preferences of the one or more end users of the application. The operation 306 may be performed by one or more hardware processors configured by machine-readable instructions including a module that is the same as or similar to the API call performing module 212, in accordance with one or more embodiments.

An operation 308 may include translating the variable based on the one or more language preference(s) of the one or more end user(s). In some embodiments the operation 308 may include translating the variable based on a master translation database. The operation 308 may be performed by one or more hardware processors configured by machine-readable instructions including a module that is the same as or similar to variable translating module 214, in accordance with one or more embodiments. In embodiments where multiple language preferences are obtained at the operation 304, the operation 308 may include an operation 310, where the variable may be translated into a first language-specific value, and an operation 312, where the variable may also be translated into a second language-specific value. It is understood that corresponding additional language-specific variables may be obtained if/when additional language preferences are obtained at the operation 304.

An operation 314 may include executing the test execution command in relation to the application element based on the one or more language-specific value(s). During execution, the variable is replaced at runtime with the applicable language-specific value for the application element. If multiple language-specific values are sent with the test execution command, the test execution command may be run multiple times, with the variable being replaced each runtime with one of the multiple language-specific values. The operation 314 may be performed by one or more hardware processors configured by machine-readable instructions including a module that is the same as or similar to test execution command executing module 218, in accordance with one or more embodiments.

After the test execution command has been executed/run with each of the language-specific values, the output(s) from the testing may be analyzed or sent to be analyzed, such as by being compared with expected outputs.

Notably, one test execution command, in the form of one line of code, may be received for the above-noted steps in the method 300 to be performed, while one or more testing outputs may be generated. As well, the language preference(s) of the end user(s) may be dynamically obtained without the tester or QE having to spend the time and processing resources to do so beforehand. Moreover, should the language preference(s) of the end user(s) change, the present method is configured to obtain the most up-to-date information without requiring the tester or QE to know or spend time and processing resources to find out that the language preference(s) have changed.

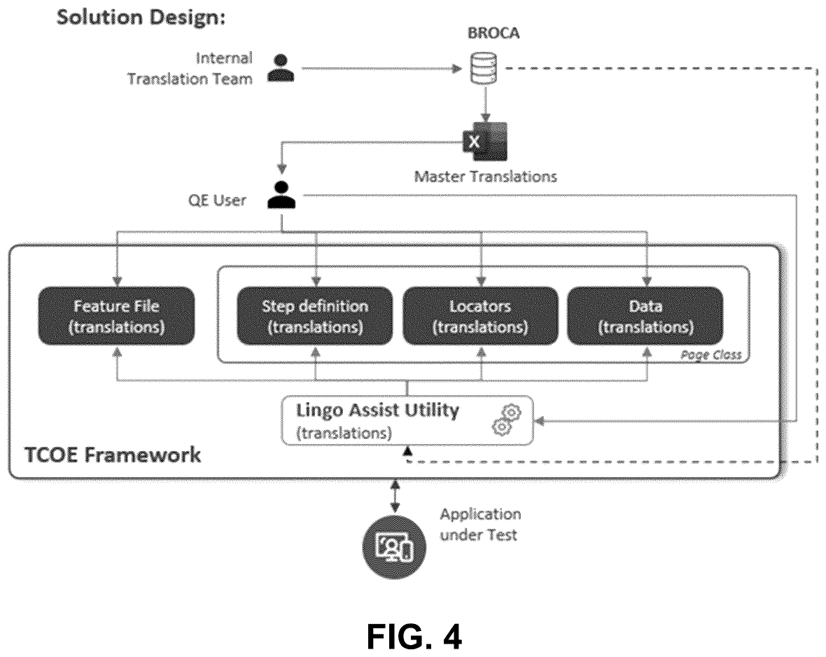

FIGS. 4-6 illustrate example aspects of the testing computing system 130 and the method 300 as described above.

FIG. 4 is a block and flow diagram illustrating the present system and method according to an embodiment of the present disclosure. The testing computing system 130 may be referred to in FIG. 4 as a lingo assist utility (LAU). The lingo assist utility is configured to receive communication, for example a test execution command, from a developer or QE user. The test execution command may include a variable associated with an application element of an application that is being tested (also referred to as an “application under test”). The LAU is configured to translate the variable to a language-specific value for the application element based on a master translation database and an end user language preference. For example, the variable may be translated into the language-specific value in one or more of: a feature file; a step definition; a locator; and other data. The LAU is also configured to execute, or to cause execution of, the test execution command in relation to the application element based on the language-specific value.

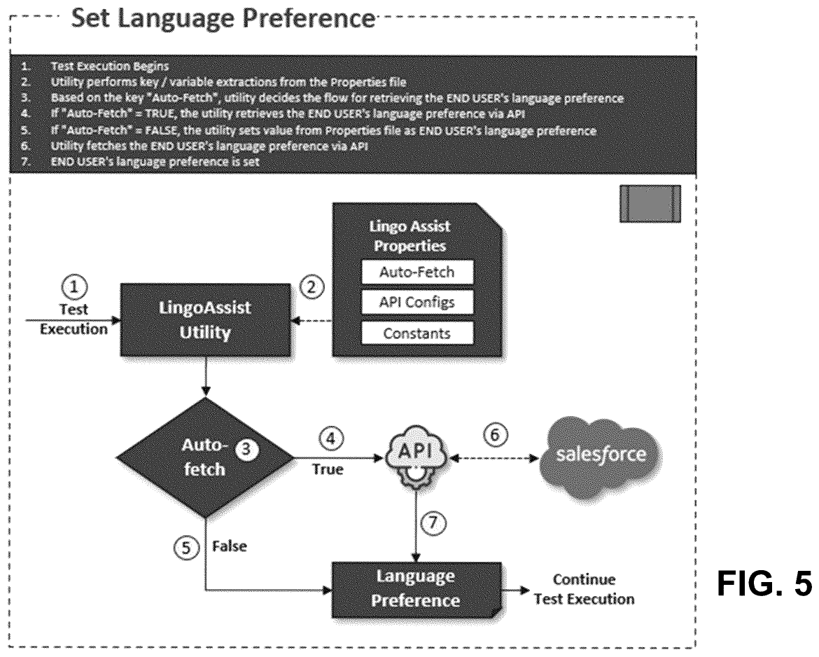

FIG. 5 is a block and flow diagram illustrating how one or more language preferences of the one or more end users may be obtained according to an embodiment of the present disclosure. At (1) the test execution beings. At (2), the LAU performs key/variable extractions from the Properties file. At (3), based on the key “Auto-Fetch”, the LAU decides the flow for retrieving the one or more end users'one or more language preference(s). At (4), if “Auto-Fetch”=TRUE, the LAU retrieves the one or more end user's one or more language preferences via an API call. At (5), if “Auto-Fetch”=FALSE, the LAU sets the value from the Properties file as the one or more end user's one or more language preference(s). At (6), the LAU fetches the one or more end user(s) one or more language preference(s) via the API call. At (7), the one or more end user(s)' one or more language preference(s) are set.

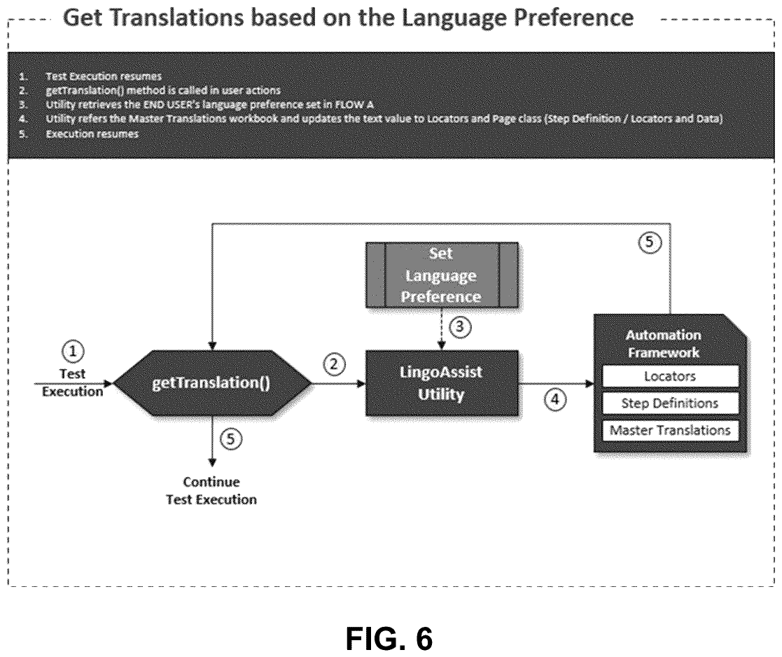

FIG. 6 is a block and flow diagram of getting translations based on a language preference according to an embodiment of the present disclosure. The process shown in FIG. 6 relates to embodiments described herein, and may be informed by or use data from the process of FIG. 5. At (1), the test execution continues after the one or more language preference(s) are set, At (2), translations are obtained, such as getTranslation( ) method is called in user actions. At (3), the LAU retrieves the one or more end user(s)' one or more language preference(s) set in FIG. 5. At (4), the LAU refers to the Master Translation database and updates the text value to Locators and Page class (Step Definition/Locators and Data). At (5), the test execution may continue by executing the test with the application under test.

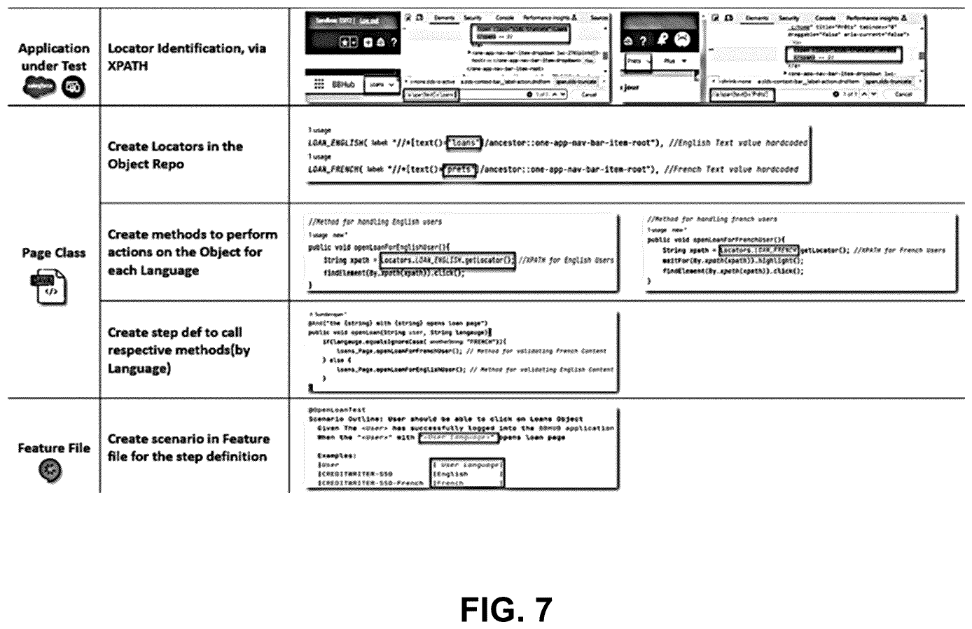

FIG. 7 illustrates steps and example software code for test execution in relation to an application under test according to a known approach. In this example, to perform test execution for the application under test in English and in French, each language version of the application under test requires separate hard-coded content in the locator identification, a page class, and in a feature file. If the application under test supports multiple languages, the code required to perform test execution for all of the language versions keeps increasing, and the risk of manual error in the test execution code also increases.

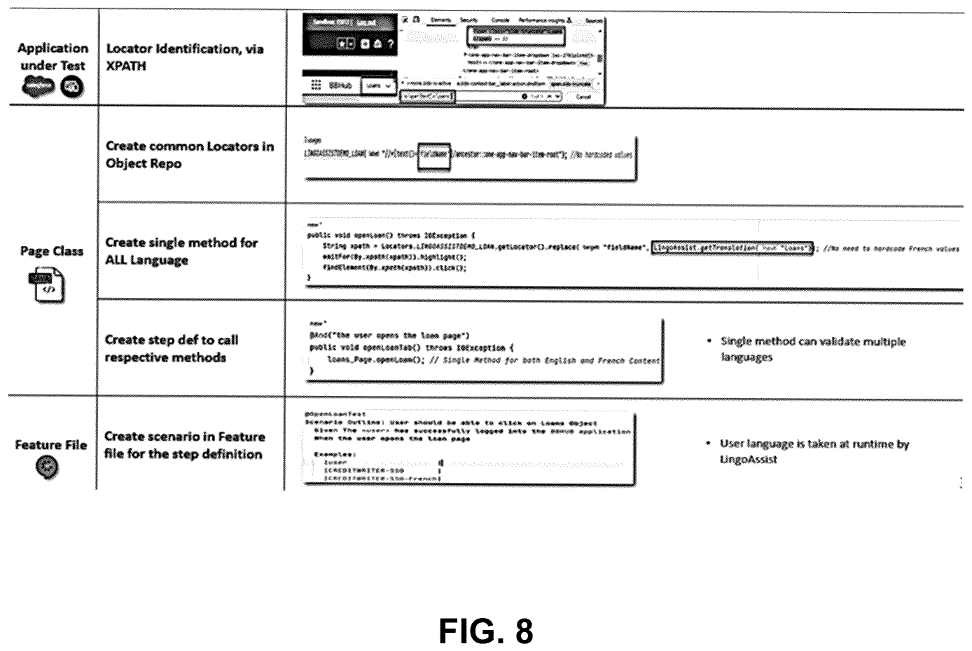

FIG. 8 illustrates steps and example software code for test execution in relation to an application under test according an embodiment of the present disclosure. In the example of FIG. 8, separate code is not required for testing each language in which the application under test is offered. Instead, a test execution command includes a single line of code that replaces the multiple lines of code in each of the instances in the locator identification, page class, and feature file. The test execution command may include a variable associated with an application element of the application under test. The present disclosure is configured to translate the variable to a language-specific value for the application element based on a master translation database and an end user language preference. The variable may be translated into the language-specific value in one or more of: a feature file; a step definition; a locator; and other data. Embodiments of the present disclosure are also configured to execute, or to cause execution of, the test execution command in relation to the application element based on the language-specific value.

The present disclosure provides a system and method to enable a developer to write code for a single test to simulate a user's behaviour in a software application, where there are multiple language versions of the same software application. Rather than have multiple hard-coded lines of code that need to be customized for each language version of the software application, the present disclosure uses a single line of code to set up testing for all of the language versions. The single line of code uses a variable that represents a software application element that may be implemented differently in each language version.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the CLAIMS appended hereto.

Embodiments of the disclosure can be described with reference to the following clauses, with specific features laid out in the dependent clauses:

One aspect of the present disclosure relates to a system comprising one or more processors, one or more communications modules coupled to the one or more processors, and at least one memory coupled to the one or more processors, the at least one memory storing computer executable instructions. When the computer executable instructions are executed by the one or more processors, that cause the system to: receive a test execution command for a first end user of an application, the test execution command including a variable associated with an application element of the application, obtain a first language preference of the first end user of the application, translate the variable to a first language-specific value for the application element based on the first language preference of the first end user, and execute the test execution command in relation to the application element based on the first language-specific value.

In some implementations of the system, the test execution command further includes an identifier of the first end user.

In some implementations of the system, the instructions, when executed by the one or more processors, cause the system to obtain the first language preference of the first end user by: performing, using the one or more communications modules, an application programming interface (API) call based on the identifier of the first end user.

In some implementations of the system, the API call is performed with the application, and the first language preference of the first end user is specific to the application.

In some implementations of the system, the test execution command comprises a single line of code.

In some implementations of the system, the instructions, when executed by the one or more processors, further cause the system to: obtain another language preference of the first end user of the application, translate the variable to another language-specific value for the application element based on a master translation database and the other language preference of the first end user, and execute the test execution command in relation to the application element based on the other language-specific value.

In some implementations of the system, the test execution command is further for a second end user of the application, and the test execution command further includes an identifier for the second end user of the application.

In some implementations of the system, the instructions, when executed by the one or more processors, further cause the system to: obtain a second language preference of the second end user, translate the variable to a second language-specific value for the application element based on the second language preference of the second end user, and execute the test execution command in relation to the application element based on the second language-specific value.

In some implementations of the system, the instructions, when executed by the one or more processors, cause the system to obtain the first language preference of the first end user and the second language preference of the second end user by: performing the API call based on the identifier of the first end user and the identifier of the second end user. In some implementations of the system, the second language preference of the second end user is specific to the application.

Another aspect of the present disclosure relates to a computer implemented method comprising: receiving a test execution command for a first end user of an application, the test execution command including a variable associated with an application element of the application, obtaining a first language preference of the first end user of the application, translating the variable to a first language-specific value for the application element based on the first language preference of the first end user, and executing the test execution command in relation to the application element based on the first language-specific value.

In some implementations of the method, the test execution command further includes an identifier of the first end user.

In some implementations of the method, obtaining the first language preference of the first end user comprises: performing an application programming interface (API) call based on the identifier of the first end user.

In some implementations of the method, the API call is performed with the application, and the first language preference of the first end user is specific to the application.

In some implementations of the method, the test execution command comprises a single line of code.

In some implementations of the method, the method further comprises: obtaining another language preference of the first end user of the application; translating the variable to another language-specific value for the application element based on the master translation database and the other language preference of the first end user, and further executing the test execution command in relation to the application element based on the other language-specific value.

In some implementations of the method, the test execution command is further for a second end user of the application, and the test execution command further includes an identifier of the second end user of the application.

In some implementations of the method, the method further comprises: obtaining a second language preference of the second end user, translating the variable to a second language-specific value for the application element based on the second language preference of the second end user, and further executing the test execution command in relation to the application element based on the second language-specific value.

In some implementations of the method, obtaining the first language preference of the first end user and the second language preference of the second end user comprises: performing the API call based on the identifier of the first end user and the identifier of the second end user.

Yet another aspect of the present disclosure relates to a non-transient computer-readable storage medium having instructions embodied thereon, the instructions being executable by one or more processors to receive a test execution command for a first end user of an application, the test execution command including a variable associated with an application element of the application, obtain a first language preference of the first end user, translate the variable to a first language-specific value for the application element based on the first language preference of the first end user, and execute the test execution command in relation to the application element based on the first language-specific value.

In some implementations of the computer-readable storage medium, the test execution command further includes an identifier of the first end user.

In some implementations of the computer-readable storage medium, obtaining the first language preference of the first end user comprises: performing an application programming interface (API) call based on the identifier of the first end user.

In some implementations of the computer-readable storage medium, the API call is performed with the application, and the first language preference of the first end user is specific to the application.

In some implementations of the computer-readable storage medium, the test execution command comprises a single line of code.

In some implementations of the computer-readable storage medium, the instructions are executable by one or more processors to further obtain another language preference of the first end user of the application; translate the variable to another language-specific value for the application element based on the master translation database and the other language preference of the first end user, and further execute the test execution command in relation to the application element based on the other language-specific value.

In some implementations of the computer-readable storage medium, the test execution command is further for a second end user of the application, and the test execution command further includes an identifier of the second end user of the application.

In some implementations of the computer-readable storage medium, the instructions are executable by one or more processors to further obtain a second language preference of the second end user, translate the variable to a second language-specific value for the application element based on the second language preference of the second end user, and further execute the test execution command in relation to the application element based on the second language-specific value.

In some implementations of the computer-readable storage medium, the instructions are executable by one or more processors to further obtain the first language preference of the first end user and the second language preference of the second end user by performing the API call based on the identifier of the first end user and the identifier of the second end user.

Still another aspect of the present disclosure relates to a system configured for executing a test execution command in relation to an application element of an application. The system may include means for receiving a test execution command including a variable associated with an application element of an application. The system may include means for obtaining a first language preference of a first end user of the application. The system may include means for translating the variable to a first language-specific value for the application element based on a master translation database and the first language preference of the first end user. The system may include means for executing the test execution command in relation to the application element based on the first language-specific value.

In some implementations of the system, the system may include means for receiving a test execution command including a variable associated with an application element of an application.

In some implementations of the system, the system may include means for obtaining a first language preference of a first end user of the application.

In some implementations of the system, the system may include means for translating the variable to a first language-specific value for the application element based on a master translation database and the first language preference of the first end user.

In some implementations of the system, the system may include means for executing the test execution command in relation to the application element based on the first language-specific value.

In some implementations of the system, the test execution command may further include an identifier of the first end user.

In some implementations of the system, the system may include means for performing an application programming interface (API) call based on the identifier of the first end user.

In some implementations of the system, the API call may be performed with the application, and the first language preference of the first end user may be specific to the application.

In some implementations of the system, the test execution command may comprise a single line of code.

In some implementations of the system, the system may include means for obtaining another language preference of the first end user of the application. In some implementations of the system, the system may include means for translating the variable to another language-specific value for the application element based on the master translation database and the other language preference of the first end user. In some implementations of the system, the system may include means for executing the test execution command in relation to the application element based on the other language-specific value.

Even another aspect of the present disclosure relates to a computing platform configured for executing a test execution command in relation to an application element of an application. The computing platform may include a non-transient computer-readable storage medium having executable instructions embodied thereon. The computing platform may include one or more hardware processors configured to execute the instructions. The processor(s) may execute the instructions to receive a test execution command including a variable associated with an application element of an application. The processor(s) may execute the instructions to obtain a first language preference of a first end user of the application. The processor(s) may execute the instructions to translate the variable to a first language-specific value for the application element based on a master translation database and the first language preference of the first end user. The processor(s) may execute the instructions to execute the test execution command in relation to the application element based on the first language-specific value.

In some implementations of the computing platform, the processor(s) may execute the instructions to receive a test execution command including a variable associated with an application element of an application.

In some implementations of the computing platform, the processor(s) may execute the instructions to obtain a first language preference of a first end user of the application.

In some implementations of the computing platform, the processor(s) may execute the instructions to translate the variable to a first language-specific value for the application element based on a master translation database and the first language preference of the first end user.

In some implementations of the computing platform, the processor(s) may execute the instructions to execute the test execution command in relation to the application element based on the first language-specific value.

In some implementations of the computing platform, the test execution command may further include an identifier of the first end user.

In some implementations of the computing platform, the processor(s) may execute the instructions to perform an application programming interface (API) call based on the identifier of the first end user.

In some implementations of the computing platform, the API call may be performed with the application, and the first language preference of the first end user may be specific to the application.

In some implementations of the computing platform, the test execution command may comprise a single line of code.

In some implementations of the computing platform, the processor(s) may execute the instructions to obtain another language preference of the first end user of the application. In some implementations of the computing platform, the processor(s) may execute the instructions to translate the variable to another language-specific value for the application element based on the master translation database and the other language preference of the first end user. In some implementations of the computing platform, the processor(s) may execute the instructions to execute the test execution command in relation to the application element based on the other language-specific value.

What is claimed is:

1. A computing system comprising:
one or more processors;
one or more communications modules coupled to the one or more processors; and
at least one memory coupled to the one or more processors, the at least one memory storing computer executable instructions that when executed by the one or more processors cause the system to:
receive a test execution command for a first end user of an application, the test execution command including a variable associated with an application element of the application;
obtain a first language preference of the first end user of the application;
translate the variable to a first language-specific value for the application element based on the first language preference of the first end user; and
execute the test execution command in relation to the application element based on the first language-specific value.

2. The system of claim 1, wherein the test execution command further includes an identifier of the first end user.

3. The system of claim 2, wherein the instructions, when executed by the one or more processors, cause the system to obtain the first language preference of the first end user by:
performing, using the one or more communications modules, an application programming interface (API) call based on the identifier of the first end user.

4. The system of claim 3, wherein the API call is performed with the application, and the first language preference of the first end user is specific to the application.

5. The system of claim 4, wherein the test execution command comprises a single line of code.

6. The system of claim 5, wherein the instructions, when executed by the one or more processors, further cause the system to:
obtain another language preference of the first end user of the application;
translate the variable to another language-specific value for the application element based on a master translation database and the other language preference of the first end user; and
further execute the test execution command in relation to the application element based on the other language-specific value.

7. The system of claim 5, wherein the test execution command is further for a second end user of the application, and the test execution command further includes an identifier for the second end user of the application.

8. The system of claim 7, wherein the instructions, when executed by the one or more processors, further cause the system to:
obtain a second language preference of the second end user;
translate the variable to a second language-specific value for the application element based on the second language preference of the second end user; and
further execute the test execution command in relation to the application element based on the second language-specific value.

9. The system of claim 8, wherein the instructions, when executed by the one or more processors, cause the system to obtain the first language preference of the first end user and the second language preference of the second end user by:
performing the API call based on the identifier of the first end user and the identifier of the second end user.

10. The system of claim 9, wherein the second language preference of the second end user is specific to the application.

11. A computer implemented method comprising:
receiving a test execution command for a first end user of an application, the test execution command including a variable associated with an application element of the application;
obtaining a first language preference of the first end user of the application;
translating the variable to a first language-specific value for the application element based on the first language preference of the first end user; and
executing the test execution command in relation to the application element based on the first language-specific value.

12. The method of claim 11, wherein the test execution command further includes an identifier of the first end user.

13. The method of claim 12, wherein obtaining the first language preference of the first end user comprises:
performing an application programming interface (API) call based on the identifier of the first end user.

14. The method of claim 13, wherein the API call is performed with the application, and the first language preference of the first end user is specific to the application.

15. The method of claim 14, wherein the test execution command comprises a single line of code.

16. The method of claim 15, further comprising:
obtaining another language preference of the first end user of the application;
translating the variable to another language-specific value for the application element based on the master translation database and the other language preference of the first end user; and
further executing the test execution command in relation to the application element based on the other language-specific value.

17. The method of claim 15, wherein the test execution command is further for a second end user of the application, and the test execution command further includes an identifier of the second end user of the application.

18. The method of claim 17, further comprising:
obtaining a second language preference of the second end user;
translating the variable to a second language-specific value for the application element based on the second language preference of the second end user; and
further executing the test execution command in relation to the application element based on the second language-specific value.

19. The method of claim 18, wherein obtaining the first language preference of the first end user and the second language preference of the second end user comprises:
performing the API call based on the identifier of the first end user and the identifier of the second end user.

20. A non-transitory, computer-readable medium storing computer-executable instructions that, when executed by a processor, are to cause the processor to:
receive a test execution command for a first end user of an application, the test execution command including a variable associated with an application element of the application;
obtain a first language preference of the first end user;
translate the variable to a first language-specific value for the application element based on the first language preference of the first end user; and
execute the test execution command in relation to the application element based on the first language-specific value.
